(19) United States
(12) Patent Application Publication
(10) Pub. No.: US 2006/0033614 A1
(43) Pub. Date: Feb. 16, 2006

(54) Sensor with two electrical terminals

(76) Inventors: Berend Kleen, Hannover (DE); Eike Lustfeld, Rehburg-Loccum (DE)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 11/202,422

(22) Filed: Aug. 11, 2005

(30) Foreign Application Priority Data
Aug. 14, 2004 (DE) 10 2004 039 518.7

(51) Int. Cl. G08B 1/08; H04B 3/54; G05B 11/01

(52) U.S. Cl. 340/538; 340/310.11; 307/1

(57) ABSTRACT

A sensor having two electrical terminals to both supply energy and to output an output signal of the sensor. The output signal of the sensor can be output via at least one of the electrical terminals without the use of a current source. The sensor includes at least one electrical component that needs an electrical energy supply to operate. The sensor also includes an output circuit which outputs the output signal by modulation of the voltage potential at at least one of the two electrical terminals. The sensor further includes a voltage-supply circuit for generating a supply voltage from the voltage potentials present at the two electrical terminals to supply energy to the electrical component.

### BACKGROUND OF THE INVENTION

The present invention relates generally to a sensor having two electrical terminals.

For sensors of the general type under consideration (such as described in WO 00/70309 A1), there is a growing need to not only equip them with passive electrical components, but also to use active electrical components, that is, electrical components that must be supplied with electrical energy in order to operate. Typically, sensors are equipped with only two electrical terminals in order to limit wiring complexity. In conventional sensors equipped with only passive electrical components, it is standard practice to use one of the terminals for the output signal of the sensor and the other terminal as the ground terminal. As regards sensors containing active electronic devices which require an electrical energy supply, it is desirable to keep them compatible with older sensors containing passive components and to avoid increasing wiring complexity—so that they can still operate with only two electrical terminals.

In sensors of the type described in WO 00/70309 A1, the two electrical terminals are therefore used to transmit electrical energy, the output signal of the sensor being delivered via one energy-supply line by modulation of the current flow. For this purpose, the sensor is provided with a controllable current source which injects information in the form of a current signal into the one energy-supply line via the output signal to be delivered by the sensor. It is a relatively complex and expensive matter to manufacture sensors having such controllable current sources. In addition, signal transmission by means of an injected current is not desirable in all practical cases, an example being the case of displacement sensors for pneumatic suspension systems in vehicles.

Accordingly, it is desired to provide a new sensor having two electrical terminals which overcomes the disadvantages associated with conventional sensors.

### SUMMARY OF THE INVENTION

Generally speaking, it is an object of the present invention to provide a sensor having two electrical terminals and containing an electrical component that requires an energy supply to operate, wherein the sensor further includes an output circuit constructed and arranged to generate an output signal by modulation of a voltage potential at at least one of the two electrical terminals, as well as a voltage-supply circuit constructed and arranged to generate a supply voltage from voltage potentials at the two electrical terminals for supplying energy to the electrical component.

It is also an object of the present invention that the output circuit be of simple construction and that the output signal of the sensor can be output without the use of a current source.

Still other objects and advantages of the present invention will in part be obvious and will in part be apparent from the specification.

The present invention accordingly comprises the features of construction, combination of elements, and arrangements of parts which will be exemplified in the construction hereinafter set forth, and the scope of the invention will be indicated in the claims.

### BRIEF DESCRIPTION OF THE DRAWINGS

For a fuller understanding of the present invention, reference is had to the following description taken in connection with the accompanying drawings in which:

FIGS. 1-4 are electrical circuit diagrams depicting various embodiments of the sensor according to the present invention.

### DETAILED DESCRIPTION OF THE PREFERRED EMBODIMENTS

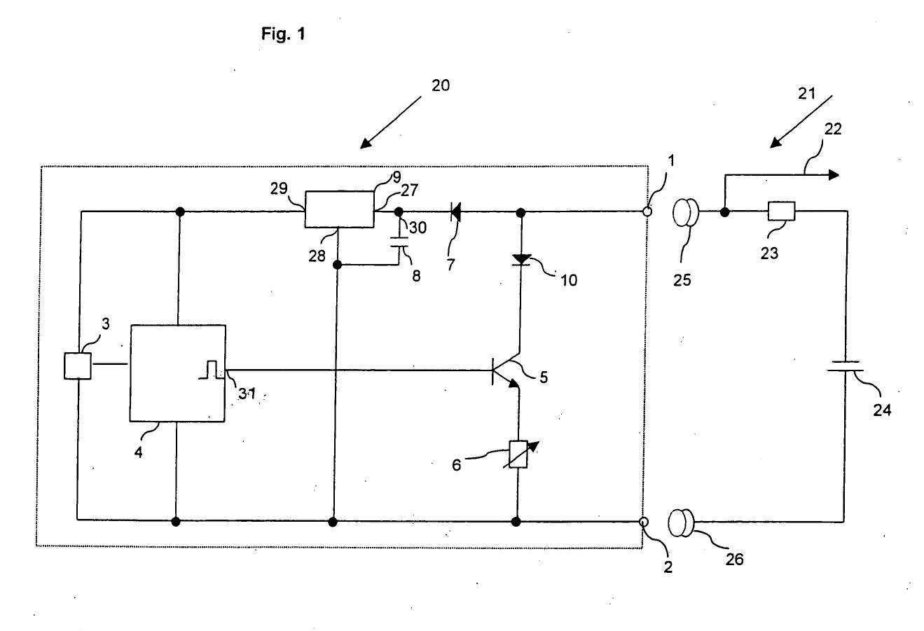

Referring to the drawing figures, where like reference numerals are used for corresponding parts, FIG. 1 shows a sensor (20) with two electrical terminals (1, 2). The term “sensor” as used hereinafter means a component that can quantitatively record at least one physical variable and can deliver an output signal corresponding to the quantity of the recorded variable. For this purpose the sensor is provided with at least one sensing element, which performs the actual recording of the physical variable. If necessary, the sensor contains further electrical components for converting the signal delivered by the sensing element to the output signal. The sensor can also be provided with a housing. Examples of the cited physical variables include electrical or magnetic field strengths, temperatures, air humidity and pressures. Practical examples using magnetic field strength include inductive velocity sensors in vehicle anti-lock brake systems or inductively operating displacement sensors in vehicle level-regulating systems.

As electrical components for operation of an electrical energy supply, sensor (20) contains a sensing element (3), a microprocessor (4) and a voltage regulator (9). An input terminal (27) of voltage regulator (9) is connected via a diode (7) to electrical terminal (1) of sensor (20). Diode (7) allows a current flow to pass from electrical terminal (1) to input terminal (27). Voltage regulator (9) is connected via a reference terminal (28) to electrical terminal (2) of sensor (20).

A capacitor (8) is also provided connected to electrical terminal (2) and to diode (7) at a common terminal point (30). Capacitor (8) provided in this way between input terminal (27) and reference terminal (28) can buffer the voltage potential present between terminals (27, 28) of voltage regulator (9). In particular, fluctuations of such voltage potential can be largely compensated in this way.

An output voltage that is largely stable as a function of time is output at an output terminal (29) of voltage regulator (9). The output voltage is fed via electrical lines to the voltage-supply terminals of sensing element (3) and of microprocessor (4). Sensing element (3) as well as microprocessor (4) are connected on the ground side via electrical lines to electrical terminal (2) of sensor (20). Thus, common terminal point (30) is used to supply voltage to voltage regulator (9) and to sensing element (3) and microprocessor (4).

Microprocessor (4) can evaluate the signal received from sensing element (3) and, in turn, deliver a signal via terminal (31) to an output circuit, which in the embodiment depicted in FIG. 1 comprises a transistor (5), an adjustable resistor (6) and a reverse-polarity-protection diode (10). Alternative constructions for the output circuit are possible. For example, instead of the bipolar transistor illustrated in FIG. 1, a field-effect transistor or any other electrical device having a comparable function can be employed.

According to FIG. 1, transistor (5) generates at electrical terminal (1), via reverse-polarity-protection diode (10), a modulated voltage potential according to the signal delivered by terminal (31) of microprocessor (4). The amplitude of this signal can be adjusted as necessary via resistor (6). Diode (10) functions to prevent damage to components of sensor (20) if electrical terminals (1, 2) are inadvertently connected to an electrical energy source in reverse polarity.

The signal delivered by microprocessor (4) via terminal (31) can be formed, for example, as a pulse-width-modulated signal or as a serial data signal. In the latter case, terminal (31) is advantageously designed as a serial data port. If a pulse-width-modulated signal is used, a plurality of information streams can be advantageously transmitted with this signal, for example, by variation of frequency and phase angle or by variation of the pulse lengths and interpulse periods. In this way, it is possible to output not only the output signal based on the signal of sensing element (3) but also further information, such as, for example, error or status information about particular operating conditions of sensor (20).

According to an advantageous embodiment of the present invention, the output signal of sensor (20) can contain information about the operating condition of sensor (20) and/or about errors that have occurred during operation of sensor (20).

Electrical terminals (1, 2) of sensor (20) are used for connection to an electrical unit, which evaluates the output signal of sensor (20) and, in addition, provides the electrical energy supply for the sensor. A subsection (21) of this electrical unit is depicted in FIG. 1, the subsection being provided with electrical terminals (25, 26) which represent the complements of electrical terminals (1, 2) of sensor (20) and to which there is connected a series circuit comprising a resistor (23) as well as an electrical energy source (24). Furthermore, via an electrical line (22), the output signal of sensor (20) is tapped between electrical terminal (25) and resistor (23) and fed to an evaluation circuit.

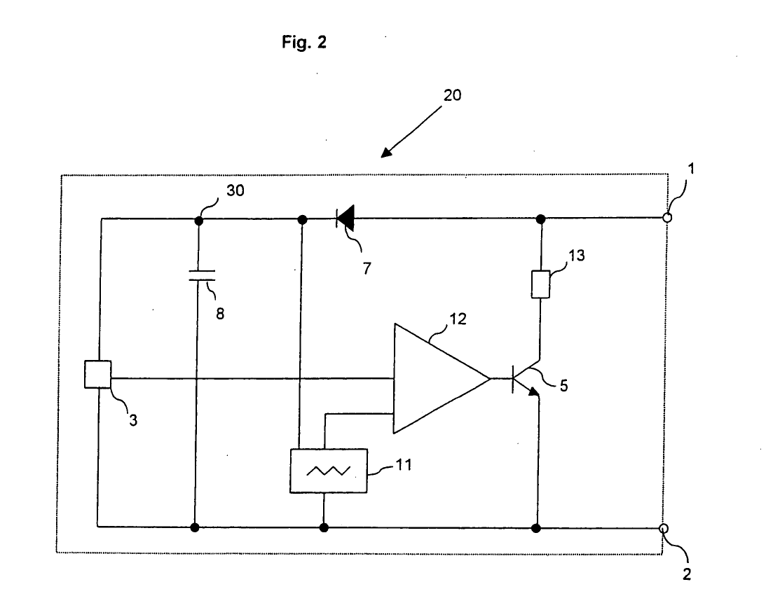

In a further embodiment of the present invention depicted in FIG. 2, sensor (20) is not provided with voltage regulator (9). In this embodiment, buffering of voltage fluctuations is achieved solely by an adequately dimensioned capacitor (8). A comparator (12) is provided instead of microprocessor (4) for processing the signal delivered by sensing element (3), the signal of sensing element (3) being fed to one input of the comparator (12). The output signal of a sawtooth generator (11) is fed to the other input of the comparator (12). In addition, for the purpose of electrical energy supply, sawtooth generator (11) is connected to electrical terminal (2) and, via diode (7), to electrical terminal (1) of sensor (20). Via the circuit arrangement of sawtooth generator (11) and comparator (12), the signal of sensing element (3) is converted to a pulse-width-modulated square-wave signal, which is delivered by the output of comparator (12) to transistor (5).

In the embodiment of the present invention depicted in FIG. 2, resistor (6) from the embodiment of the invention depicted in FIG. 1 (where the resistor is disposed in the circuit branch connected to electrical terminal (2)), is substituted by a resistor (13) disposed in the circuit branch connected to electrical terminal (1). The reverse-polarity-protection diode is not provided in the embodiment depicted in FIG. 2. In one advantageous configuration, safety against reverse polarity is achieved by mechanical coding of an electrical plug connector containing electrical terminals (1, 2).

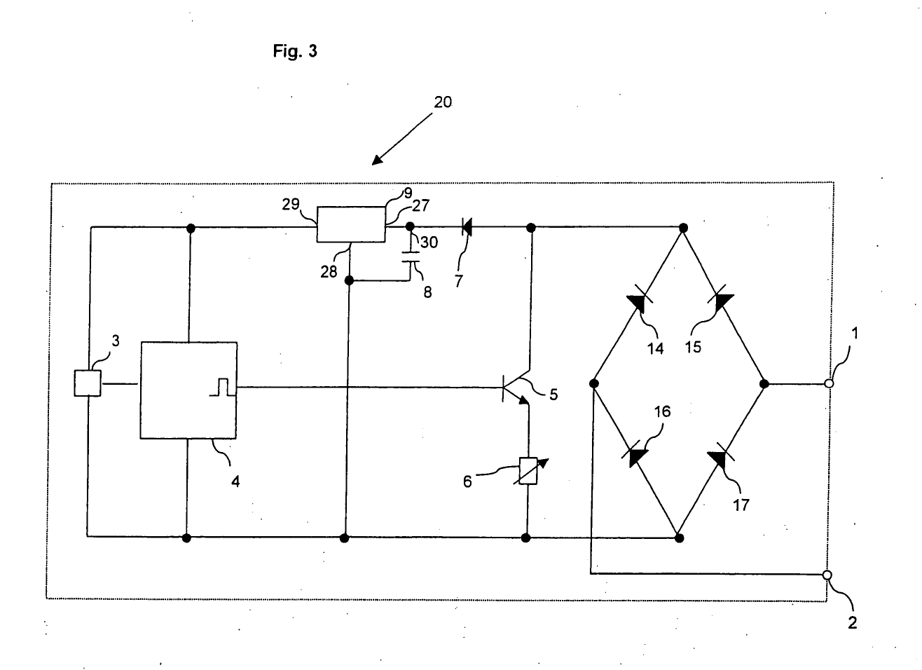

In the embodiment of the present invention depicted in FIG. 3, sensor (20) is provided with the components found in the embodiment depicted in FIG. 1, although without reverse-polarity-protection diode (10). Compared with FIG. 1, there is additionally provided a polarity-coordinating circuit (14, 15, 16, 17) designed as a type of bridge rectifier and composed of four diodes (14, 15, 16, 17). By means of two opposite points of the bridge circuit, the polarity-coordinating circuit is connected to electrical terminals (1, 2). The other opposite points of the bridge circuit are connected to the circuit arrangement described above in connection with the embodiment depicted in FIG. 1. The polarity-coordinating circuit provides that electrical terminals (1, 2) can be connected with arbitrary polarity to electrical unit subsection (21).

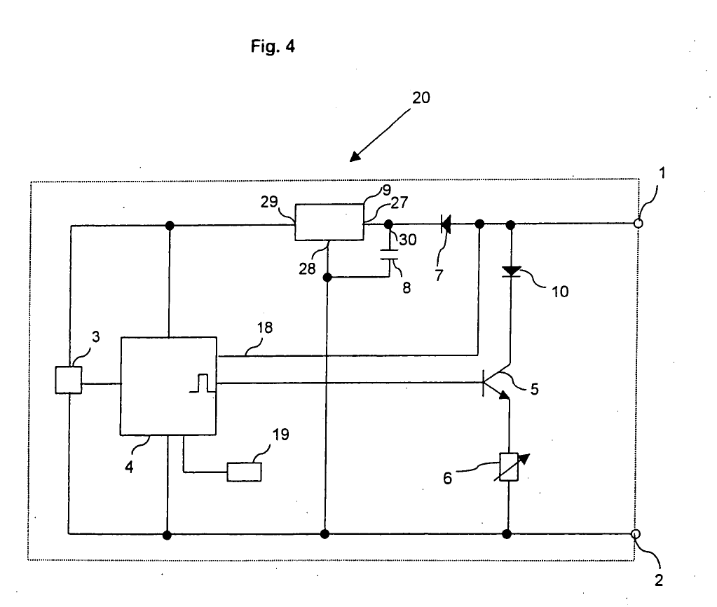

The embodiment of sensor (20) according to the present invention depicted in FIG. 4 differs from the embodiment depicted in FIG. 1 by a further electrical line (18) by which the one input terminal of microprocessor (4) is directly connected to electrical terminal (1) of sensor (20). The input terminal of microprocessor (4) connected to line (18) can be advantageously designed as a serial interface terminal. Furthermore, microprocessor (4) is connected to a data memory (19) (whose electrical connections to the energy supply are not shown in FIG. 4 to simplify the drawing figure). In an advantageous configuration of the present invention, the sensor is then designed to receive data via the two electrical terminals (1, 2). This can be achieved, for example, by the fact that electrical unit (21) connected to electrical terminals (1, 2) transmits a serial data signal via electrical terminal (1) and consequently via electrical line (18) to microprocessor (4). Microprocessor (4) evaluates the received data and stores them as needed in data memory (19). By designing data memory (19) as a non-volatile memory, once data have been stored therein, they are preserved even after sensor (20) has been disconnected from the electrical energy supply. As an example, the data transmitted via line (18) can be used for programming or calibrating the sensor. Thus, a measurement range to be used or a particular resolution of the data to be output can be assigned to the sensor via the transmitted data.

Accordingly, the present invention provides a sensor having two electrical terminals including an electrical circuit of simple and inexpensive construction for generating an output signal by modulation of the voltage potential at at least one of the two electrical terminals. A voltage-supply circuit for supplying at least one electrical component contained in the sensor is also provided and is also of simple and inexpensive construction. Advantageously, the voltage-supply circuit generates the supply voltage from the voltage potentials present at the two electrical terminals.

It will thus be seen that the objects set forth above, among those made apparent from the preceding description, are efficiently attained, and since certain changes may be made in the above constructions without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

1. A sensor, comprising two electrical terminals, and at least one electrical component requiring an electrical energy supply to operate, said two electrical terminals constructed and arranged to supply energy and to output an output signal of said sensor, said sensor further comprising an output circuit constructed and arranged to output said output signal by modulation of a voltage potential at at least one of said two electrical terminals, a voltage-supply circuit constructed and arranged to generate a supply voltage from voltage potentials at said two electrical terminals for supplying energy to said at least one electrical component.

2. The sensor according to claim 1, wherein said voltage-supply circuit includes (i) at least one diode connected to one of said two electrical terminals, and (ii) a capacitor connected to the other one of said two electrical terminals, said diode and said capacitor being connected to one another at a common terminal point, said common terminal point functioning to supply voltage to at least said at least one electrical component.

3. The sensor according to claim 1, wherein said voltage-supply circuit includes a voltage regulator.

4. The sensor according to claim 1, wherein said output circuit includes a transistor connected at least one of directly and by further electrical devices to said two electrical terminals.

5. The sensor according to claim 4, wherein said further electrical devices include at least one resistor.

6. The sensor according to claim 4, wherein said further electrical devices include a reverse-polarity-protection diode.

7. The sensor according to claim 1, further comprising a polarity-coordinating circuit constructed and arranged to shield said sensor against reverse polarity.

8. The sensor according to claim 1, wherein said at least one electrical component includes a microprocessor.

9. The sensor according to claim 1, wherein said output signal is at least one of a pulse-width-modulated signal and a serial data signal.

10. The sensor according to claim 1, wherein said output signal includes information about at least one of an operating condition of said sensor and an error occurring during operation of said sensor.

11. The sensor according to claim 1, wherein said sensor is constructed and arranged to receive data via said two electrical terminals.

12. The sensor according to claim 11, further comprising a memory for storing data received via said two electrical terminals.
